(19) United States
(12) Patent Application Publication
(10) Pub. No.: US 2012/0049548 A1
(43) Pub. Date: Mar. 1, 2012

(54) PORTABLE PET WASTE CATCH AND TRANSPORT SYSTEM

(76) Inventor: Emma Williams, Silver Spring, MD (US)

(21) Appl. No.: 12/974,463

(22) Filed: Dec. 21, 2010

Related U.S. Application Data
(60) Provisional application No. 61/344,617, filed on Aug. 31, 2010.

(51) Int. Cl. A01K 29/00

(52) U.S. Cl. 294/1.5

(57) ABSTRACT

A portable system is provided for easy catching and transporting pet waste. The portable system includes a main shaft with a soft handle and a wrist band on one end, an extension shaft coupled to the main shaft at the other end of the main shaft for length adjustment, an attachment shaft coupled to the extension shaft, and a bag configured to be slid on the attachment shaft to catch and transport pet waste.

### CROSS-REFERENCES TO RELATED APPLICATIONS

This application claims the priority of U.S. Provisional Patent Application No. 61/344,617, filed on Aug. 31, 2010, the entire contents of which are incorporated herein by reference.

### FIELD OF THE INVENTION

This invention relates to a portable catch and transport system to be used for cleanup of pet waste produced by pet animals outdoors.

### BACKGROUND

The number of pet population in the United States is very large and still increasing. The Humane Society estimated that there are approximately 77.5 million owned dogs in the United States, with 39% of U.S. households own at least one dog and some owners own two or more dogs. Assuming each pet dog poops twice a day on average, the total amount of waste generated each day by pet dogs is huge. Dogs are routinely walked outdoors and it is estimated that about 40% of the dog owners do not pick up their dogs' waste.

Unattended dog waste not only leaves ugly scenes in nature, but also pollutes our environment and drinking water and makes it unsafe for children to play in the park, to run around a field, or to walk in the street freely without rolling or stepping on dog waste. Such problems also impact people's views toward pet dogs, by leaving the impression that dogs are a nuisance and dirty because they poop everywhere.

While litter boxes for indoor use are available in pet stores, and dog owners have been using shovels and plastic bags to pickup dog waste outdoors, there is no convenient portable cleanup system that helps dog owners and protects the environment. More importantly, the vast majority of dog owners currently only cleanup after the dog waste already hit ground, which increases the difficulty of cleaning and often leaves marks on the ground. It is almost impossible for a dog owner to hold a plastic bag near the dog's bottom to wait for the waste to come out.

The disclosed methods and systems are directed to solve one or more problems set forth above and other problems.

### BRIEF SUMMARY OF THE DISCLOSURE

One aspect of the present disclosure provides a portable system for easy catching and transporting pet waste. The portable system includes a main shaft with a soft handle and a wrist band on one end, an extension shaft coupled to the main shaft at the other end of the main shaft for length adjustment, an attachment shaft coupled to the extension shaft, and a bag configured to be slid on the attachment shaft to catch and transport pet waste.

Other aspects of the present disclosure can be understood by those skilled in the art in light of the description, the claims, and the drawings of the present disclosure.

### BRIEF DESCRIPTION OF THE DRAWINGS

FIG. 1A illustrates a front view of an exemplary pet waste portable system consistent with the disclosed embodiments;

FIG. 1B illustrates a front view of another exemplary pet waste portable system consistent with the disclosed embodiments;

FIG. 2 illustrates a side view of another exemplary pet waste portable system assembling diagram consistent with the disclosed embodiments; and

FIG. 3 illustrates a side view of another exemplary pet waste portable system assembled diagram consistent with the disclosed embodiments;

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

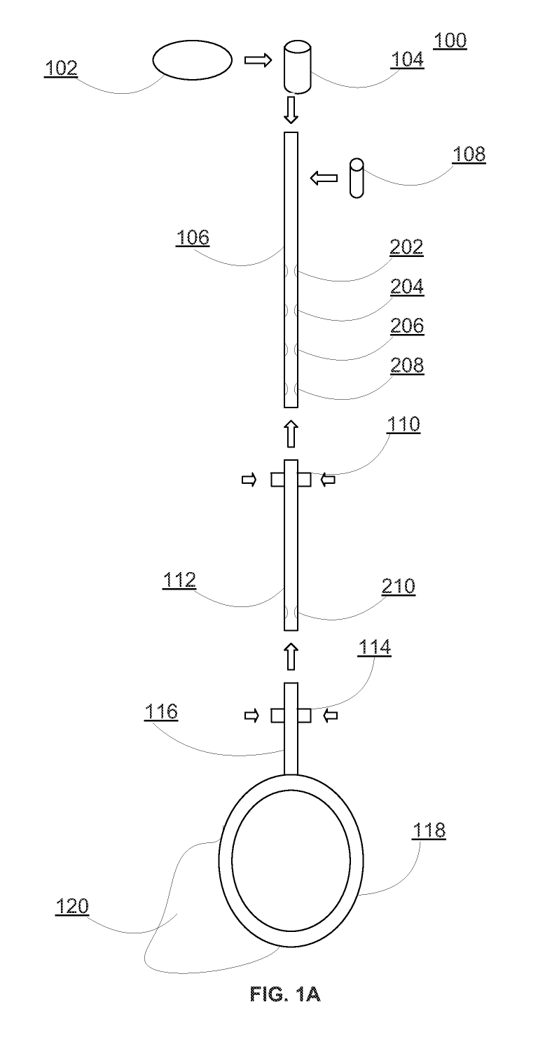

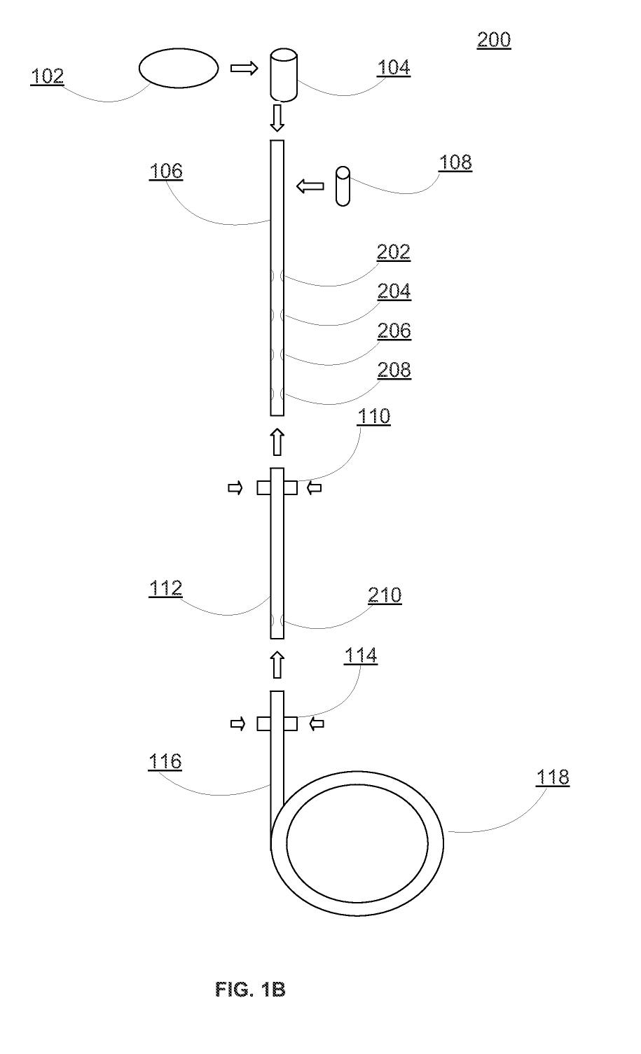

The present disclosure provides a portable system for easy catch and transport of pet waste. FIG. 1A shows a front view of an exemplary pet waste portable system assembling diagram with a loop attachment on bottom consistent with the disclosed embodiments.

As shown in FIG. 1A, pet waste portable system 100 includes a main shaft 106 with a soft handle 104 and a wristband 102 on top, an extension shaft 112 in the middle and a bottom attachment shaft 116, on which a bag may be placed on loop attachment 118 to catch and transport pet waste. A flashlight 108 may be attached to main shaft 106 to provide good visibility in the dark. Flashlight 108 may also be configured in certain position such that loop attachment 118 may be directly put underneath a dog's bottom in the dark. Further, the built-in flashlight 108 may be weather resistant to be able to function even if it rains or snows.

An extension shaft 112 is attached to the main shaft 106 with an adjustable length system 110 to fit different user height. The length adjust system 110 may include any appropriate components for easy length adjustment, for example, a push-in button. The push-in button 110 may be on one end of the extension shaft 112 and can be pushed in and inserted into the main shaft 106. On main shaft 106, there are holes in certain position for different length, for example, short position 202, middle position 204, medium long position 206 and long position 208. Once the push-in button 110 reaches those holes, the pressed-in button of push-in button 110 shafts out and latches in the hole at certain position (e.g., 202, 204, 206, or 208). Further, the push-in button 110 may allow adding on any appropriate additional attachment, for example, a decorative attachment or a functional attachment such as deodorant, toy, and massager. Furthermore the extension shaft 112 may be made of any appropriate material, for example, metal, plastic, wood.

A bottom attachment shaft 116 may be connected to the extension shaft 112. The bottom attachment shaft 116 includes a detachable system 114 on one end and a loop attachment 118 on the other end. Detachable system 114 may include appropriate components capable of detachment and attachment, for example, a push-in button. For attachment, push-in button 114 is pushed in and inserted into extension shaft 112 until it latches in hole 210 on extension shaft 112. For detachment, push-in button 114 is pressed inwards to hole 210 on extension shaft 112, and attachment shaft 116 can then be withdrawn out of extension shaft 112. Detachable system 114 makes it easier for user to switch to different loop sizes, to slide on and to refill a pet waste bag.

Loop attachment 118 may have any appropriate sizes to fit different pet sizes, for example, small, medium and big. Further the loop attachment 118 may be connected to the attachment shaft 116 at any appropriate position. For example, the loop attachment 118 may be connected to the attachment shaft 116 on top of the attachment shaft 116 with the middle of attachment shaft 116 as shown in FIG. 1A, or on a side of the attachment shaft 116 with the side of attachment shaft 116 as shown in FIG. 1B, which illustrates a side view of an assembling diagram of an exemplary pet waste portable system 200.

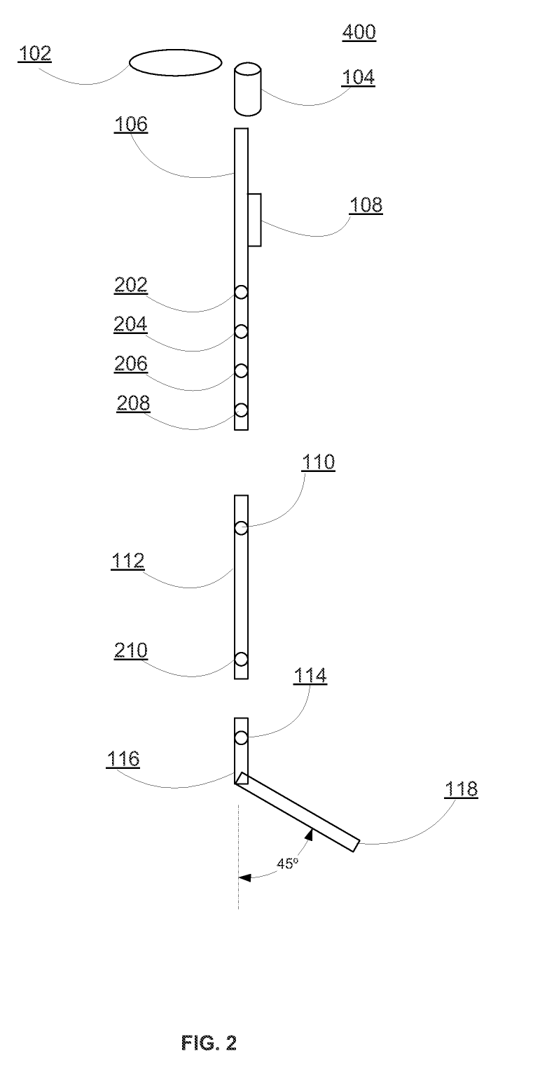

Further, the loop attachment 118 may be in any appropriate angles related to the attachment shaft 116. For example, the loop attachment 118 may be positioned in a 45-degree angle related to the attachment shaft 116, as shown in FIG. 2, which illustrates the side view of an assembling diagram of an exemplary pet waste portable system 400 consistent with the disclosed embodiments.

Furthermore, the loop attachment 118 may be taken in any appropriate shape, for example, ring, ellipse, polygons, and made of metal or plastic material. For example, loop attachment 118 may be a metal ring with a rounded edge and an appropriate diameter, such that loop attachment 118 may have sufficient strength to push down tall grass, a pile of leaves, or a pile of snow, etc. Further, a rounded edge metal wire is also desired for a plastic bag and since the metal ring is sturdy, it can also carry the weight of the dog waste, even sometimes with rain water or snow.

A bag 120 can be inserted overlapping the loop attachment 118 (e.g., a ring) to hold pet waste and the bag may be made from any appropriate material, for example, plastic or biodegradable plastic. Further, the bag 120 may have a draw string on lip for easy disposal. Bag 120 may include various sizes corresponding to the size of loop attachment 118. For example, bag 120 may have 3 sizes for small, medium, and large loop attachment 118.

The loop attachment 118 attached with bag 120 may be configured in such a way to be separated from main shaft 106 or extension shaft 112 for easy slide of bag 120 after use or easy bag refill. Further, the main shaft 106 may be made from any appropriate material strong enough to hold the portable system and pet waste, for example, metal, plastic or wood. For example, main shaft 106 and/or extension shaft 112 may also be made of metal to enhance durability of pet waste portable systems.

A soft handle 104 is attached to one end of the main shaft 106 and it may be made from any appropriate material for better grip, for example, rubber, plastic, wood or fabrics. Further, soft handle 104 may have any appropriate colors and logos. A wristband 102 may be attached to the main shaft 106 or the soft handle 104 for easy carry and hanging when not in use, it may be made from any appropriate material, for example, plastic, fabrics. Wristband 102 may have appropriate colors and logos.

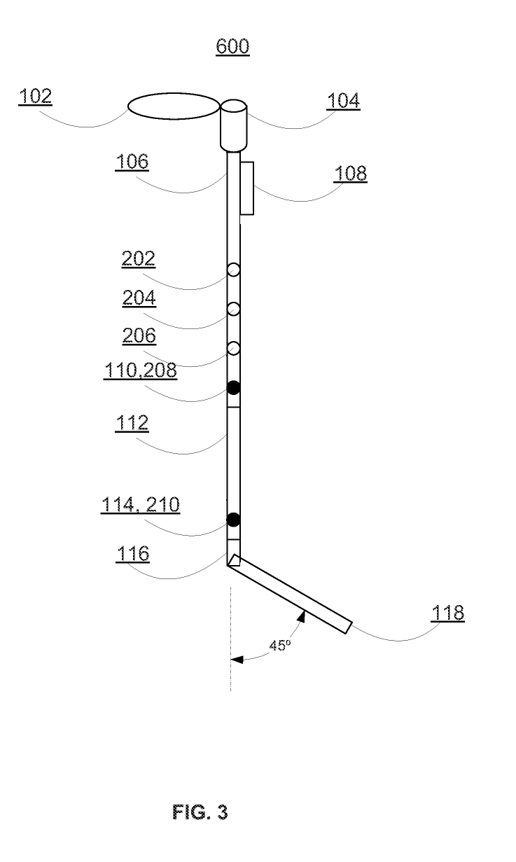

FIG. 3 shows a side view of an assembled diagram of an exemplary pet waste portable system 600 consistent with the disclosed embodiments. As shown in FIG. 3, the assembled system 600 is adjusted to a long position, with the push-in button 110 of extension shaft 112 latched on long position 208 of main shaft 106. Being connected with wristband 102, soft handle 104 is put on the top of main shaft 106. Loop attachment shaft 116 is attached to extension shaft 112 by push-in button 114 latched on hole 210. Further, the loop attachment 118 is positioned in a 45-degree angle related to the attachment shaft 116. Other configurations may also be used.

With the disclosed systems, dog owners will be able to carry portable catch-and-transport systems along with them, for their morning and evening walks, to catch pet dog waste before it hits the ground and do not have to pick it up. The disclosed systems also help keeping our environment.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

For example, extension shaft 112 and/or loop attachment shaft 116 may be omitted. Loop attachment 118 may thus be attached to extension shaft 112 or main shaft 106, such that alternative configurations may be created. Other configurations can also be created based on the principles disclosed and understood by those skilled in the art.

1. A portable pet waste catch and transport system, comprising:
a main shaft having a first end and a second end, and a plurality of retaining holes configured in pairs;
a soft handle and a wrist band coupled to the first end of the main shaft;
an extension shaft having a proximal end, a distal end, and a coupling member located near the proximal end that detachably couples the extension shaft to a pair of retaining holes from the plurality of retaining holes of the main shaft at the second end of the main shaft;
an attachment shaft detachably coupled to the distal end of the extension shaft and having an upper end and a lower end;
one of a plurality of replacement loops of different sizes selectively coupled at the lower end of the attachment shaft; and
a bag configured to be slid to the one replacement loop to catch and transport pet waste.

2. The portable pet waste catch and transport system according to claim 1, wherein:
the coupling member is a push-in button that fits in any pair of retaining holes on the main shaft, and
the extension shaft is configured to be coupled to the main shaft by latching the push-in button in the pair of retaining holes and to be detached from the main shaft by disengaging the push-in button from the pair of retaining holes.

3. (canceled)

4. The portable pet waste catch and transport system according to claim 1, further comprising:
a pair of transverse holes located near the distal end of the extension shaft,
a push-in button located near the upper end of the attachment shaft,
wherein:
the attachment shaft can be attached to the extension shaft by latching the push-in button in the pair of transverse holes; and
the attachment shaft can be detached from the extension shaft by disengaging the push-in button from the pair of transverse hole.

5. (canceled)

6. (canceled)

7. (canceled)

8. The portable pet waste catch and transport system according to claim 1, wherein:
the loop is in a shape of one of ring, ellipse, and polygon.

9. The portable pet waste catch and transport system according to claim 1, wherein:
the loop is on bottom of the attachment shaft.

10. The portable pet waste catch and transport system according to claim 8, wherein:
the loop is on side of the attachment shaft.

11. The portable pet waste catch and transport system according to claim 1, wherein:
the loop is at an angle related to the attachment shaft.

12. The portable pet waste catch and transport system according to claim 1, wherein:
an environmental friendly bag can be slid on the loop to catch and transport pet waste.

13. The portable pet waste catch and transport system according to claim 1, wherein:
the wrist band is made of one of plastic and fabric.

14. The portable pet waste catch and transport system according to claim 1, wherein:
the soft handle is made of one of rubber, plastic, wood, metal, and fabric.

15. The portable pet waste catch and transport system according to claim 1, wherein:
the main shaft is made of one of metal, plastic, and wood.

16. The portable pet waste catch and transport system according to claim 1, wherein:
the extension shaft is made of one of metal, plastic, and wood.

17. The portable pet waste catch and transport system according to claim 1, wherein:
the attachment shaft is made of one of metal, plastic, and wood.

18. The portable pet waste catch and transport system according to claim 1, wherein:
the bag is made of biodegradable plastic.

19. (canceled)
